(19) United States
(12) Patent Application Publication
(10) Pub. No.: US 2013/0088423 A1
(43) Pub. Date: Apr. 11, 2013

(54) KEY INPUT APPARATUS FOR PORTABLE TERMINAL

(71) Applicant: Hyung-Gon Kim, Dalseo-gu (KR)

(72) Inventor: Hyung-Gon Kim, Dalseo-gu (KR)

(73) Assignee: SAMSUNG ELECTRONICS CO., LTD., Suwon-si (KR)

(21) Appl. No.: 13/619,370

(22) Filed: Sep. 14, 2012

(30) Foreign Application Priority Data
Oct. 7, 2011 (KR) 10-2011-0102445

(51) Int. Cl. G06F 3/01

(52) U.S. Cl. 345/156

(57) ABSTRACT

A key input apparatus and a portable terminal having the key input apparatus are provided. The key input apparatus includes a main board, a display having flexibility and elasticity and at least one pressing switch placed between the main board and the display.

### CROSS-REFERENCE TO RELATED APPLICATION(S) AND CLAIM OF PRIORITY

The present application is related to and claims the benefit under 35 U.S.C. §119(a) of a Korean patent application No. 10-2011-0102445, filed on Oct. 7, 2011, in the Korean Intellectual Property Office, the entire disclosure of which is hereby incorporated by reference.

### TECHNICAL FIELD OF THE INVENTION

The present invention relates to a key input apparatus and a portable terminal having a key input apparatus.

### BACKGROUND OF THE INVENTION

With the development of electronics communication industries in recent years, an electronic apparatus such as a mobile communication terminal (or a cellular phone), an electronics organizer, a Personal Digital Assistant (PDA), etc., has become necessities of modem life as an important means for delivering information which changes rapidly.

FIG. 1 is a perspective view of a typical touch screen portable terminal. The touch screen portable terminal 10 includes the power key 14 and the volume control key on a lateral portion. However, these keys may be damaged by an external factor such as sweat and moisture and may be against the recent design trend.

### SUMMARY OF THE INVENTION

To address the above-discussed deficiencies of the prior art, it is a primary object to provide a key input apparatus capable of replacing an exterior key of the portable terminal.

Another aspect of the present invention is to provide a key input apparatus capable of turning, on or off the power of a portable terminal when a proper position on a screen is pressed.

In accordance with an aspect of the present invention, a key input apparatus and a portable terminal having a key input apparatus are provided. The key input apparatus can include a main board, a display having flexibility and elasticity, and at least one pressing switch which is placed between the main board and the display.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view of a typical touch screen portable terminal;

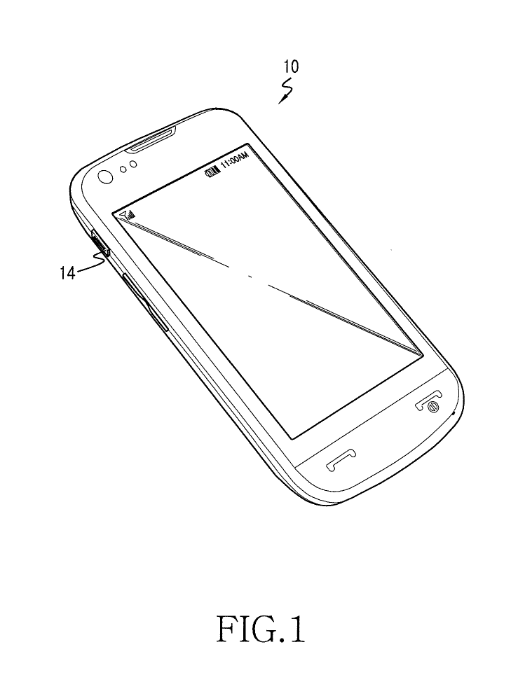

FIG. 2 is a perspective view of a touch screen portable terminal according to one embodiment of the present disclosure;

FIG. 3 illustrates cross section views of a key input apparatus before and after pressing the key input according to one embodiment of the present disclosure;

FIG. 4 illustrates cross section views of a key input apparatus before and after pressing the key input according to one embodiment of the present disclosure; and

FIG. 5 illustrates screens before and after touching a key input apparatus according to one embodiment of the present disclosure.

### DETAILED DESCRIPTION OF THE INVENTION

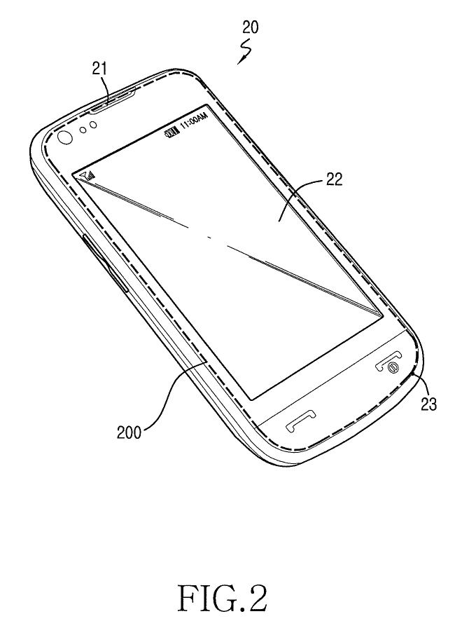

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications device. Exemplary embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

The present invention relates to a key input apparatus capable of replacing the exterior keys of a portable terminal. The key input apparatus according to one embodiment of the present disclosure is a key input apparatus capable of turning on or off the power of a portable terminal when a proper position of a screen is pressed.

FIG. 2 is a perspective view of a touch screen portable terminal according to one embodiment of the present disclosure.

A portable terminal 20 includes a speaker 21 for outputting electrical signal into audio signal, a touch screen 22 for outputting electrical signal into video signal and for receiving electrical signal based on a touch, and a microphone 23 for converting audio signal into electrical signal.

The touch screen portable terminal 20 includes a power key which can turn on or off power in a front portion 200. In particular, the touch screen 22 can have flexibility and elasticity, and the power key can be placed below the touch screen 22. In certain embodiments, when a user presses a proper position of the touch screen 22, the power key is pressed.

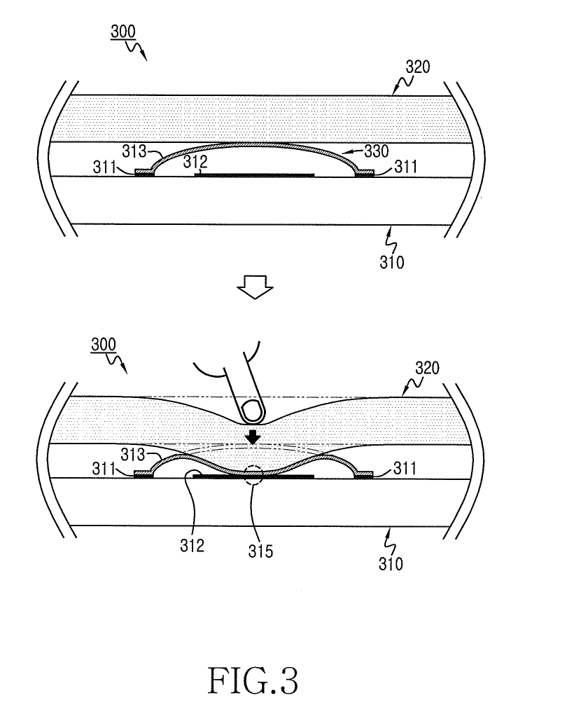

FIG. 3 illustrates cross section views of a key input apparatus according, to an exemplary embodiment of the present invention. A key input apparatus 300 of the present invention includes a main board 310, a touch screen 320 laminated on the main board 310 and a pressing switch which can be placed between the main board 310 and the touch screen 320.

A key input apparatus 300 of the present invention includes a main board 310, a touch screen 320 laminated on the main board 310, and a pressing switch placed between the two elements.

The main board 310 comprises a board containing a basic circuit and components on the basic circuit. The main board 310 configures an execution environment of a terminal and maintains information thereof, allows the terminal to operate reliably, and facilitates data input/output exchange of all elements of the terminal. Components placed on the main board 310 can include a Central Processing Unit (CPU), a microprocessor, a co-processor, a memory, a BIOS, a connection circuit, and the like.

The touch screen 320 includes a display and a touch panel attached on the display, and the shape of the touch screen can be modified. In certain embodiment, the display and the touch panel can be formed with a material having flexibility, thus the display and the touch panel can have flexibility and elasticity.

The pressing switch 330 includes first and second conductive pads 311 and 312 placed on the main board 310 and a conductive elastic dome 313 which is in contact with the first pad 311 and of which an uplifted upper portion is placed above the second pad 312. Further, the pressing switch 330 can have a film for isolating the elastic dome 313 from the touch screen 320.

Since the touch screen 320 has flexibility, a user can press the conductive elastic dome 313 when the user presses a proper position of the touch screen 320. In this case, the lifted upper portion of the conductive elastic dome 313 is brought into contact with the second pad 312, the first pad 311 and the second pad 312 are electrically connected, and the main board 310 detects that the switch is on.

When the pressing is released, the touch screen 320 and the conductive elastic dome 313 are restored, the first pad 311 and the second pad 312 are electrically disconnected, and the main board 310 detects that the switch is off.

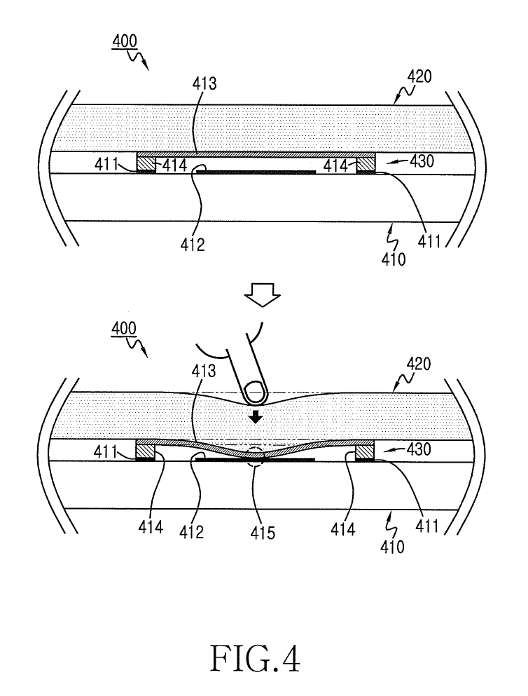

FIG. 4 illustrates cross section views of a key input apparatus before and after pressing the key input according to one embodiment of the present invention.

A key input apparatus 400 of the present disclosure includes a main board 410, a touch screen 420 laminated on the main board 410 and a pressing switch placed between the main board 410 and the touch screen 420.

The touch screen 420 includes a display and a touch panel attached on the display, and can modify these elements. In certain embodiments, the display and the touch panel can have flexibility and elasticity.

The pressing switch 430 includes first and second conductive pads 411 and 412 placed on the main board 410 and a conductive film 413 having flexibility and placed below the touch screen 420 in such a manner that the conductive film is in contact with the first pad 411 and is spaced apart from the second pad. The switch 430 includes a member 414 for electrically connecting the first pad 411 and the conductive film 413. Further, the pressing switch 430 can have a film for isolating the elastic dome 413 from the touch screen 420. The conductive film 413 can be an Indium Tin Oxide (ITO) film, a carbon nano-tube film, a graphene film, a gold film, a silver film, and the like.

Since the touch screen 420 has flexibility, when a user presses a proper position of the touch screen 420, the conductive elastic film 413 which is stretched together with the touch screen 420 is brought into contact with the second pad 412, the first pad 411 and the second pad 412 are electrically connected, and the main board 410 detects that a switch is on.

When the pressing is released, the touch screen 420 and the conductive elastic film 413 are restored, the first pad 411 and the second pad 412 are electrically disconnected, and the main board 410 detects that the switch is off.

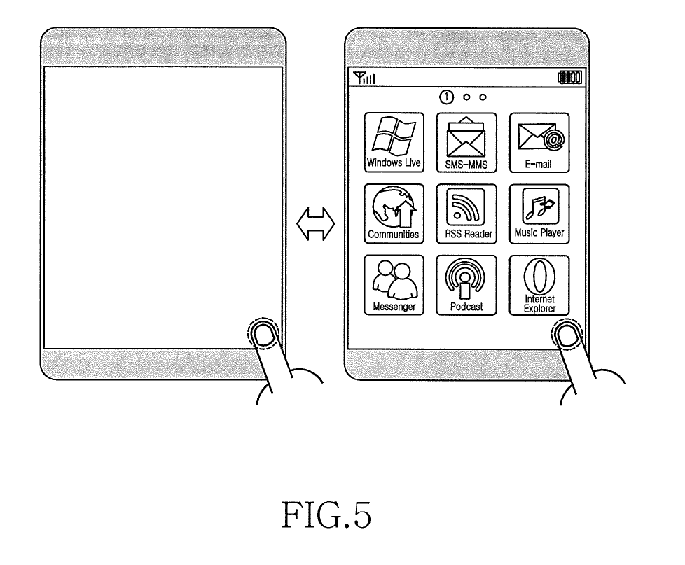

FIG. 5 illustrates changes on a screen before and after pressing a key input apparatus according to one embodiment of the present disclosure.

A user presses a proper position of a touch screen when power of a portable terminal is turned on or off. The position to be pressed can be indicated by a character, a symbol, a color, and the like.

The present disclosure is not limited to the touch screen portable terminal, and can also apply to a typical display portable terminal. In certain embodiments, in order to implement the key input apparatus of the present disclosure, the display portable terminal includes a display having flexibility. Such a structure allows a user to experience an input generated by a touch of the display portable terminal.

In conclusion, a key input apparatus of a portable terminal of the present invention can not only beautify the terminal but also protect the terminal from an outer damage factor.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A key input apparatus comprising:
a main board;
a display having flexibility and elasticity; and
at least one pressing switch placed between the main board and the display.

2. The apparatus of claim 1, wherein the pressing switch comprises:
first and second conductive pads placed on the main board; and
a conductive elastic dome which is in contact with the first pad, a lifted upper portion of the conductive elastic dome being placed above the second pad.

3. The apparatus of claim 1, wherein the pressing switch comprises:
first and second conductive pads placed on the main board; and
a conductive film having flexibility and placed below the display in such a manner that the conductive film is in contact with the first pad and is spaced apart from the second pad.

4. The apparatus of claim 3, wherein the conductive film is one of an Indium Tin Oxide (ITO) film, a carbon nano-tube film, a graphene film, a gold film and a silver film.

5. The apparatus of claim 1, further comprising a film, placed between the display and the switch, for isolating the display from the switch.

6. The apparatus of claim 1, further comprising a touch panel which is attached to the display and which has flexibility and elasticity.

7. The apparatus of claim 1, wherein if the pressing switch connects an electrical path, the main board either turns on or turns off power of the portable terminal.

8. The apparatus of claim 1, wherein the display provides an indication for indicating the pressing switch in a lower portion of the display.

9. The apparatus of claim 2, wherein the lifted upper portion of the conductive elastic dome contacts the second pad to connect an electrical path upon user's pressure.

10. The apparatus of claim 3, wherein the conductive film contacts the second pad to connect an electrical path upon user's pressure.

11. A mobile terminal having a key input apparatus comprising:
a main board;
a display having flexibility and elasticity; and
at least one pressing switch placed between the main board and the display.

12. The mobile terminal of claim 11, wherein the pressing switch comprises:
first and second conductive pads placed on the main board; and
a conductive elastic dome which is in contact with the first pad, a lifted upper portion of the conductive elastic dome being placed above the second pad.

13. The mobile terminal of claim 11, wherein the pressing switch comprises:
first and second conductive pads placed on the main board; and
a conductive film having flexibility and placed below the display in such a manner that the conductive film is in contact with the first pad and is spaced apart from the second pad.

14. The mobile terminal of claim 13, wherein the conductive film is one of an Indium Tin Oxide (ITO) film, a carbon nano-tube film, a graphene film, a gold film and a silver film.

15. The mobile terminal of claim 11, further comprising a film, placed between the display and the switch, for isolating the display from the switch.

16. The mobile terminal of claim 11, further comprising a touch panel which is attached to the display and which has flexibility and elasticity.

17. The mobile terminal of claim 11, wherein if the pressing switch connects an electrical path, the main board either turns on or turns off power of the portable terminal.

18. The mobile terminal of claim 11, wherein the display provides an indication for indicating the pressing switch in a lower portion of the display.

19. The mobile terminal of claim 12, wherein the lifted upper portion of the conductive elastic dome contacts the second pad to connect an electrical path upon user's pressure.

20. The mobile terminal of claim 13, wherein the conductive film contacts the second pad to connect an electrical path upon user's pressure.
